(19) United States
(12) Patent Application Publication
(10) Pub. No.: US 2011/0168285 A1
(43) Pub. Date: Jul. 14, 2011

(54) MODULAR COOLING FLUID MANIFOLD

(76) Inventor: Ron L. Seabolt, Sparta, MI (US)

(21) Appl. No.: 13/005,328

(22) Filed: Jan. 12, 2011

Related U.S. Application Data
(60) Provisional application No. 61/294,258, filed on Jan. 12, 2010.

(51) Int. Cl. F16K 11/00

(52) U.S. Cl. 137/884

(57) ABSTRACT

A modular fluid manifold for accommodating a flow of fluid from a fluid source to at least one distribution point comprises at least two modules. Each module includes a body, openings, at least one fixture port, at least one through-hole, and at least one fastener. The body includes a pair of opposed end faces, a bottom face and an opposed top face, and a pair of opposed side faces. An opening in each of the opposed end faces is fluidly coupled to define a portion of an interior chamber extending through the body. The fixture ports are fluidly coupled with the portion of the interior chamber. The through-hole extends through the body between the opposed end faces. The at least one fastener can be inserted through the at least one through-hole to fixedly join the at least two modules into the modular fluid manifold.

### CROSS-REFERENCE TO RELATED APPLICATION

This application claims the benefit of U.S. provisional application Ser. No. 61/294,258, filed Jan. 12, 2010, which is incorporated by reference herein in its entirety.

### BACKGROUND OF THE INVENTION

1. Field of the Invention

The invention relates to a fluid manifold for distributing fluids to an apparatus, such as a plastics injection molding machine and, in particular, to a modular cooling fluid manifold.

2. Description of the Related Art

Manufacturing operations, such as injection molding of plastics, can entail elevated temperatures of the fabrication apparatus and the raw materials used for the fabricated product. It can be necessary, then, to maintain the temperature of the fabrication apparatus and product below a fixed limit to prevent the apparatus from overheating and expedite removal of the product from the apparatus, thereby facilitating an optimal production cycle. Generally, temperature control, i.e. cooling, is accomplished by pumping water, synthetic coolant, or other cooling fluid, through passageways in the fabrication apparatus. Coolant is delivered along a cooling circuit from a heat exchanger, such as a cooling tower or chiller, as a low temperature fluid, through the passageways in the apparatus, and back to the heat exchanger as a high temperature fluid, where it is again cooled. Cooling manifolds control the distribution of coolant to and from selected regions of a fabrication apparatus, and can be complex depending on the number and configuration of the passageways in the apparatus. Such manifolds can frequently be configured for a specific fabrication apparatus, with a preselected number of fluid inlets and outlets distributed throughout a rigid, heavy, hollow body.

Frequently, it becomes necessary to change the fabrication apparatus for a different product or operation. It may be necessary to modify the cooling circuit configuration because of this change in apparatus. This modification will often center around changing manifolds and the appurtenant nipples, tees and/or other splitters, various hose connection fittings, and cooling fluid hoses. Changing out such a system can be complicated and time-consuming. Disassembly and replacement of cooling system components can involve a lengthy shut-down of production.

### BRIEF DESCRIPTION OF THE INVENTION

A modular fluid manifold for accommodating a flow of fluid from a fluid source to at least one distribution point comprises at least two modules. Each module includes a body, openings, at least one fixture port, at least one through-hole, and at least one fastener. The body includes a pair of opposed end faces, a bottom face and an opposed top face, and a pair of opposed side faces. An opening in each of the opposed end faces is fluidly coupled to define a portion of an interior chamber extending through the body. The fixture ports are fluidly coupled with the portion of the interior chamber. The through-hole extends through the body between the opposed end faces. The at least one fastener can be inserted through the at least one through-hole to fixedly join the at least two modules into the modular fluid manifold.

These and other features and advantages of the invention will become apparent from the detailed description below, in light of the accompanying drawings.

### BRIEF DESCRIPTION OF THE DRAWINGS

In the drawings:

FIG. 1 is a perspective view of a fluid manifold according to a first embodiment of the invention.

FIG. 2 is a perspective view of a body module of the fluid manifold illustrated in FIG. 1.

FIG. 3 is a perspective view of a first end module of the fluid manifold illustrated in FIG. 1.

FIG. 4 is a perspective view of a second end module of the fluid manifold illustrated in FIG. 1.

FIG. 5 is a perspective view of a stop module of the fluid manifold illustrated in FIG. 1.

FIG. 6 is an exploded view of a fluid manifold according to a second embodiment of the invention.

FIG. 7 is an exploded view of a fluid manifold according to a third embodiment of the invention.

FIG. 8 is a perspective view of a fluid manifold according to a fourth embodiment of the invention.

### DESCRIPTION OF EXEMPLARY EMBODIMENTS OF THE INVENTION

The modular fluid manifold is described herein in the context of a heat-generating process requiring a cooling fluid. However, the apparatus may alternatively be utilized in other processes not requiring a cooling fluid.

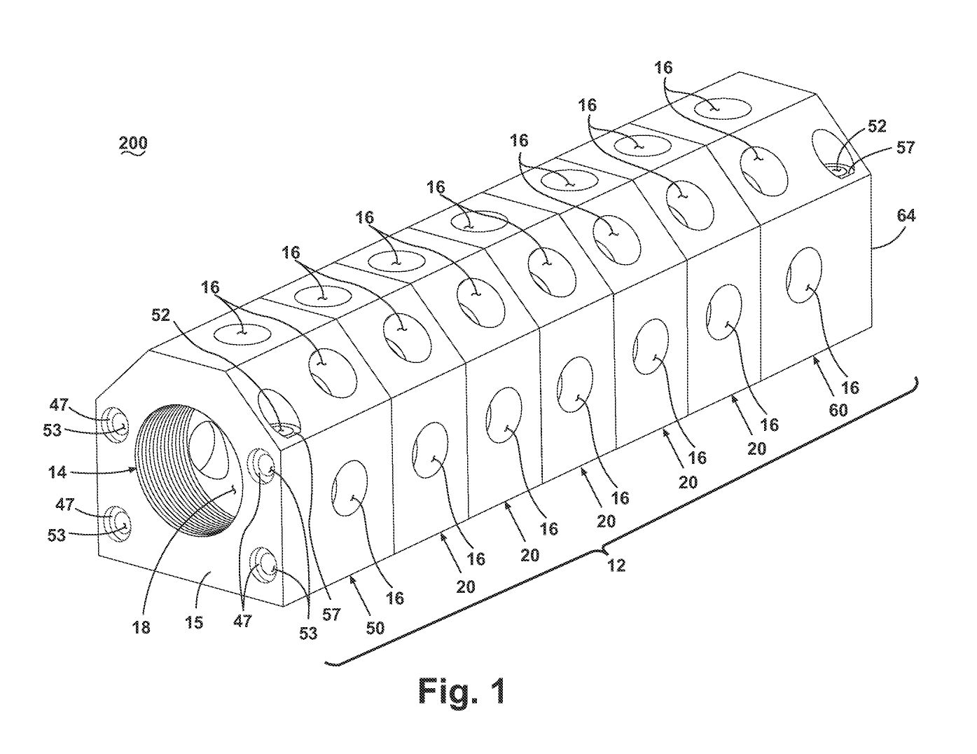

Referring to FIG. 1 of the drawings, a first exemplary embodiment of the invention is illustrated comprising a modular cooling fluid manifold 10 having a modular manifold body 12 with a first end face opening 14 through a first end face and a plurality of fixture ports 16. The fluid manifold 10 forms a portion of a fluid cooling circuit for cooling a fabrication apparatus (not shown) and a product fabricated therein. The fluid manifold 10 routes cooling fluid from a fluid source, i.e. a cooling tower or chiller (not shown), to a plurality of distribution points, i.e. cooling fluid passages, in the fabrication apparatus. Warmed cooling fluid that has circulated through the fabrication apparatus returns through the fluid manifold 10 to the cooling tower/chiller, where heat generated during the fabrication process is removed.

The modular manifold body 12 defines an interior fluid chamber 18, and includes a selected number of modules: a body module 20, a first end module 50, and a second end module 60. The modular manifold body 12 can also include a stop module (not shown), described hereinafter. Each module 20, 50, 60 is illustrated as generally rectilinear in shape, with two adjacent corners being chamfered. Alternatively, all modules described herein can have other shapes, such as cubical, prismatic (e.g. a hexagonal prism), cylindrical, and the like.

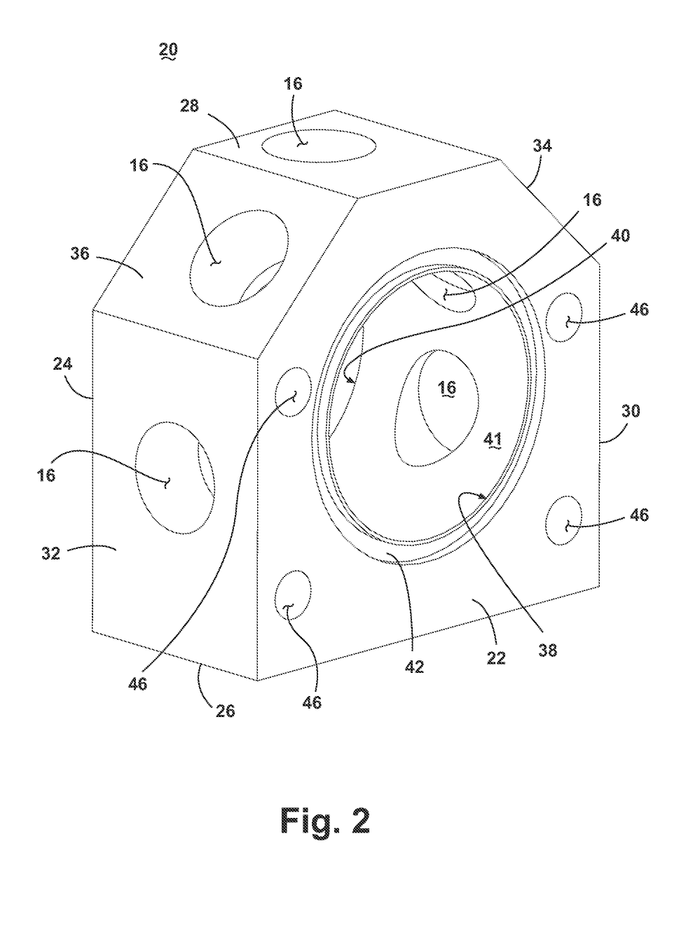

The body module 20 illustrated herein can be characterized by eight planar faces which are defined relative to the orientation illustrated in FIG. 2: a pair of end faces hereinafter referred to as a first abutment face 22 and an opposed second abutment face 24, a bottom face 26, an opposed top face 28, a first side face 30, an opposed second side face 32, a first chamfered face 34, and a second chamfered face 36. The body module 20 can have a fixture port 16 through each of the top, first side, second side, first chamfered, and second chamfered faces 28, 30, 32, 34, 36 for fluid communication with the interior chamber 18, and thus with each other fixture port 16. Each fixture port 16 can be internally threaded (not shown) to accommodate a mating threaded coupling (not shown) for fluid connected thereto. Alternatively, the fixture ports can have integral threaded couplings, quick-connect couplings, and the like. Moreover, the body module 20 can be provided with a larger or smaller numbers of fixture ports 16, or different fixture port configurations, than illustrated.

FIG. 2 illustrates the body module 20 including a circular first interior chamber opening 38 through the first abutment face 22, and a circular second interior chamber opening 40 through the second abutment face 24. The cylindrical space 41 between the first and second interior chamber openings 38, 40 can be in fluid communication with, and can define a portion of, the interior chamber 18. Alternatively, the configuration of the interior chamber and chamber openings can be square, hexagonal, or other selected shape.

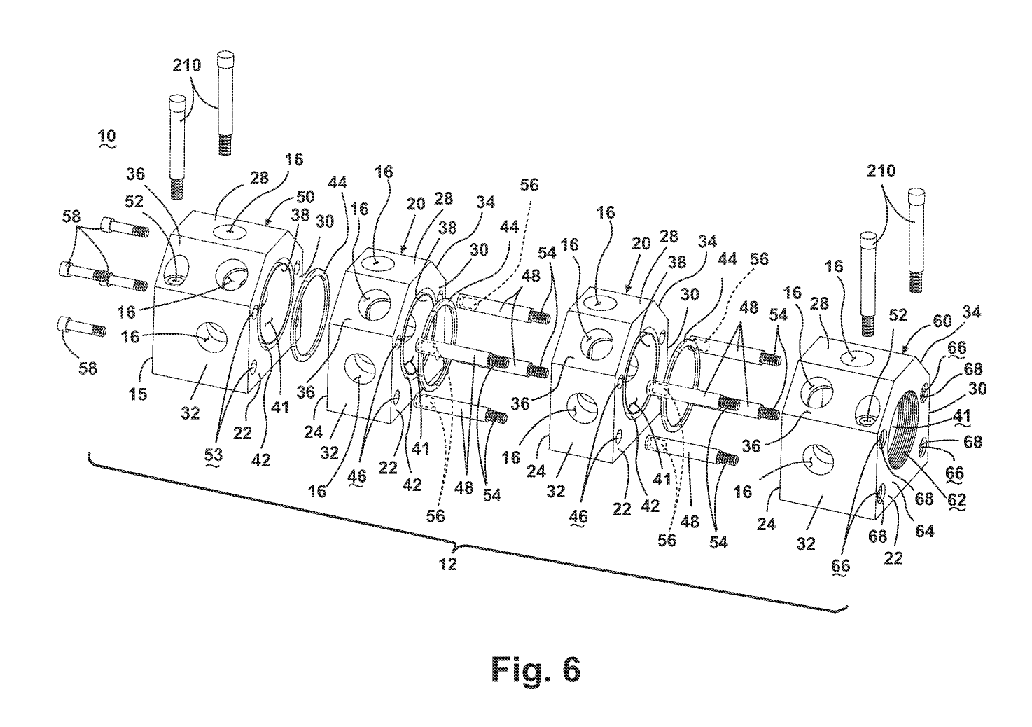

FIG. 2 also illustrates an annular groove 42 depending from the first abutment face 22 to encircle the first interior chamber opening 38. A sealing device 44, such as a rubber O-ring (FIG. 6), can be seated in the groove 42 to provide a fluid-proof seal between the first abutment face 22 and the second abutment face 24 when the modular cooling fluid manifold 10 is fully assembled. Alternatively, a gasket or rectilinear rubber seal can be used in a suitably-shaped groove or sandwiched between the abutment faces to provide the fluid-proof seal, particularly in a modular cooling fluid manifold with an interior chamber opening and interior chamber having other than a circular shape.

The body module 20 can also include a plurality of smooth-sided circular through-holes 46 penetrating the first and second abutment faces 22, 24 and passing through the body module 20 parallel to the interior chamber 18 for receiving an elongated, smooth-sided, cylindrical rod-like fastener 48, hereinafter referred to as a tie-rod (FIG. 6). Four through-holes 46 are illustrated; alternatively, a larger or smaller number can be utilized.

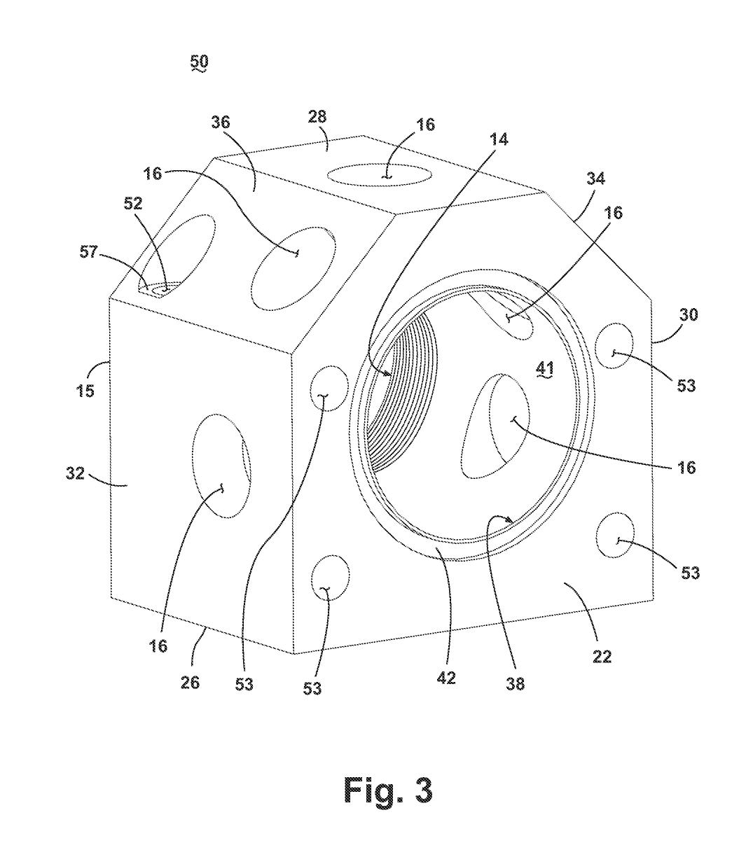

Referring now to FIG. 3, the first end module 50 can have a configuration similar, and generally complementary, to the configuration of the body module 20, including an abutment face 22, an opposed first end face 15, a bottom face 26, an opposed top face 28, a first side face 30, an opposed second side face 32, a first chamfered face 34, and a second chamfered face 36. Fixture ports 16 can extend through the top, first side, second side, first chamfered, and second chamfered faces 28, 30, 32, 34, 36 for fluid communication with the interior chamber 18 and each other fixture port. Each fixture port 16 can be internally threaded (not shown) to accommodate a mating threaded coupling (not shown) for fluid connection thereto. Alternatively, the first end module 50 can include fixture ports with integral fixed couplings. The first end module 50 can be provided with a larger or smaller numbers of fixture ports 16, or different fixture port configurations, than illustrated herein.

The first end face opening 14 can extend through the first end face 15, and can be internally threaded for fluid coupling with a mating fluid conduit (not shown) coupled into the fluid cooling circuit. A first interior chamber opening 38 can extend through the abutment face 22, encircled by an annular groove 42, with a sealing device 44, such as a rubber O-ring, seated in the groove 42 to seal the first interior chamber opening 38 against an adjoining second abutment face 24. The first end face opening 14 and first interior chamber opening 38 can be in fluid communication with, and can define a portion of, the interior chamber 18.

The first end module 50 can include a plurality of smooth-sided circular through-holes 53 penetrating the abutment face 22 and first end face 15, and passing through the first end module 50 parallel to the interior chamber 18. Four through-holes 53 are illustrated; alternatively, a larger or smaller number can be utilized.

Each through-hole 53 of the first end module 50 can include a countersunk stepped annular shoulder 47 (see FIG. 1) depending from the first end face 15 to enable a fastener, such as a threaded cap screw 58 (FIGS. 6 & 7), to extend through the through-hole 53, with the cap end of the cap screw 58 retained against the annular shoulder 47. The threaded end of the cap screw 58 can be threadably coupled with the threaded receiving end 56 of a tie-rod 48, as illustrated in FIG. 6.

The first end module 50 can include at least one mounting bore 52 extending from each chamfered face 34, 36 through the bottom face 26 for attaching the first end module 50 to a support base (not shown) with a suitable threaded fastener. The mounting bore 52 can be encircled by a countersunk stepped annular shoulder 57.

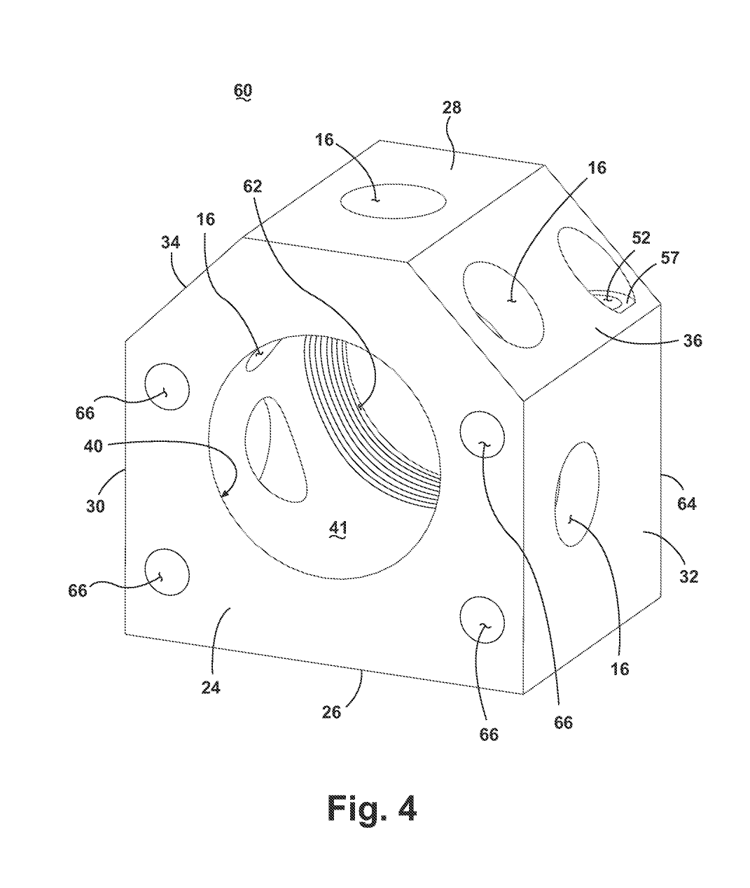

Referring now to FIG. 4, the second end module 60 can have a configuration similar, and generally complementary, to the configuration of the body module 20, including an abutment face 24, an opposed second end face 64, a bottom face 26, an opposed top face 28, a first side face 30, an opposed second side face 32, a first chamfered face 34, and a second chamfered face 36. Fixture ports 16 can extend through the top, first side, second side, first chamfered, and second chamfered faces 28, 30, 32, 34, 36 for fluid communication with the interior chamber 18 and each other fixture port 16.

Each fixture port 16 can be internally threaded (not shown) to accommodate a mating threaded coupling (not shown) for fluid connection thereto. Alternatively, the second end module 60 can include fixture ports with integral fixed couplings. The second end module 60 can be provided with a larger or smaller numbers of fixture ports 16, or different fixture port configurations, than illustrated herein.

A second end face opening 62 can extend through the second end face 64, and can be internally threaded for fluid coupling with a mating fluid conduit (not shown) coupled into the fluid cooling circuit. A second interior chamber opening 40 can extend through the abutment face 24. The second end face opening 62 and second interior chamber opening 40 can be in fluid communication with, and can define a portion of, the interior chamber 18.

The second end module 60 can include a plurality of smooth-sided circular through-holes 66 penetrating the abutment face 24 and second end face 64, and passing through the second end module 60 parallel to the interior chamber 18, to enable a tie-rod threaded insertion end 54 to extend therethrough. The threaded insertion end 54 can terminate adjacent, and just short of, the second end face 64 of the assembled manifold body 12. Four through-holes 66 are illustrated; alternatively, a larger or smaller number can be utilized.

Each through-hole 66 of the second end module 60 can include a countersunk stepped annular shoulder 68 (FIG. 6) depending from the second end face 64 to enable a threaded nut (not shown) to be seated into the through-hole 66, with the nut retained against the annular shoulder 68. The nut can be threaded onto the threaded insertion end 54 of a tie-rod 48 to bear against the annular shoulder 68 and hold the modular cooling fluid manifold 10 together. Alternatively, a portion of the through-hole 66 adjacent the second end face 64 of the second end module 60 can be internally threaded for direct coupling with the threaded insertion end 54 of the tie-rod 48.

The second end module 60 can include at least one mounting bore 52 extending from each chamfered face 34, 36 through the bottom face 26 for attaching the second end module 60 to a support base (not shown) with a suitable threaded fastener. The mounting bore 52 can be encircled by a countersunk stepped annular shoulder 57.

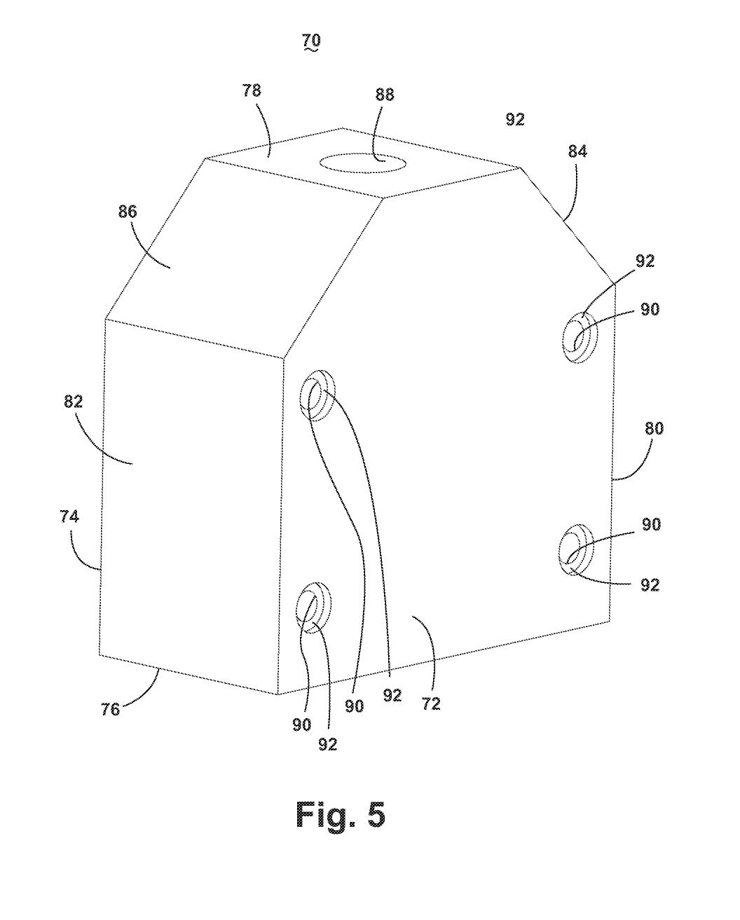

As illustrated in FIG. 5, a stop module 70 can have a configuration generally complementary to the configuration of the body module 20, first end module 50, and second end module 60, but it is without fluid openings or fixture ports, and thus, does not define a portion of the interior chamber 18, and does not pass cooling fluid.

The stop module 70 can include a first abutment face 72, an opposed second abutment face 74, a bottom face 76, an opposed top face 78, a first side face 80, an opposed second side face 82, a first chamfered face 84, and a second chamfered face 86. A mounting bore 88 similar to the mounting bore 52 can extend from the top face 78 through the bottom face 76.

As with the body module 20, a plurality of smooth-sided circular through-holes 90 can penetrate the first and second abutment faces 72, 74, to extend through the stop module 70. The through-holes 90 can enable the incorporation of the stop module 70 between body modules 20 using the tie-rods 48 as previously described herein. Four through-holes 90 are illustrated; alternatively, a larger or smaller number can be utilized.

As illustrated in FIG. 5, each through-hole 90 can alternatively include a countersunk stepped annular shoulder 92 depending from one or both abutment faces 72, 74 when the stop module 70 is to serve as an end module in a manifold body. An annular groove (not shown) as described hereinbefore, can be provided in one or both stop module abutment faces when a stop module is to adjoin a module having a face such as the abutment face 24.

Multiple combinations of the body module 20, first end module 50, second end module 60, and stop module 70 can be utilized to form a manifold body, readily providing a modular assembly, and adding cooling capacity to the manifold 10 in preselected increments. Each through-hole 46, 53, 66, 90 can receive a cap screw 58 or a tie-rod, as appropriate to the associated module. Each tie-rod 48 can have an externally-threaded insertion end 54 and an internally-threaded receiving end 56, the ends 54, 56 having complementary threads. Multiple tie-rods 48 can thus be threadably coupled, insertion end 54 to receiving end 56, into a tie-rod string having a selected length generally equivalent to a selected manifold length. In general, the length of each tie-rod 48 can be equal to the length of a module, i.e. the distance between opposed abutment faces or opposed end and abutment faces.

In a second exemplary embodiment of the invention illustrated in FIG. 6, the manifold 10 includes a first end module 50, a plurality (here 2) of body modules 20, and a second end module 60; however any combination of modules can be joined to define a preselected manifold configuration. Relative to the orientation illustrated in FIG. 6, the first end module 50 can be positioned on the left end of the manifold 10. Two body modules 20 can be located adjacent the first end module 50 and can be oriented with their first interior chamber openings 38 on the left. The second end module 60 can be positioned on the right end of the manifold 10.

An O-ring 44 seated in the annular groove 42 of each of the first end module 50 and the two body modules 20 can provide a seal against the non-grooved face of an adjoining module. The modules 50, 20, 20, 60 can be fastened together by a tie-rod string. A first tie-rod 48 can be threadably engaged with a second tie-rod 48, and the two connected tie-rods 48 can extend through the through-holes 46 of the two body modules 20, 20. An externally threaded cap screw 58 can extend through the through-hole 53 of the first end module 50 and threadably connect with the internally threaded receiving end 56 of the first tie-rod 48. The cap screw 58 can bear against the annular shoulder 47 in the countersunk through-hole 53. Tie-rods 48 can be added to provide a finished length appropriate for coupling all selected modules into a modular manifold body 12. This configuration can be repeated for each through-hole 46. The tie-rods 48 can connect the individual modules into a rigid, fluid-tight manifold by tightening a nut onto the insertion end 54 of each tie-rod 48 and against the annular shoulder 68 associated with the through-hole 66 of the second end module 60.

When necessary, one or more modules can be quickly removed from or added to the manifold 10 in response to a need to reconfigure the cooling system. Cooling fluid lines can remain connected to modules that will continue in use, thereby expediting modifications to the manifold, minimizing down time, simplifying coolant plumbing, and reducing costs.

In operation, referring to FIG. 6, the first end face opening 14 of the first end module 50 can be fluidly coupled with a primary fluid line (not shown) associated with a cooling circuit supplying coolant to a heat-generating industrial production process. Secondary fluid lines (not shown) can be fluidly coupled to each of the fixture ports 16 and a fabrication apparatus for distribution through the fixture ports 16 to the fabrication apparatus fluid passages (not shown).

A line (not shown) can be coupled with the second end face opening 62 of the second end module 60 to provide cooling fluid to a second manifold. Alternatively, a suitable stopper, such as a threaded plug (not shown), can be installed in the outlet 62. A stop module 70 can also be coupled as hereinbefore described with an end body module 20 to close an end of the manifold 10.

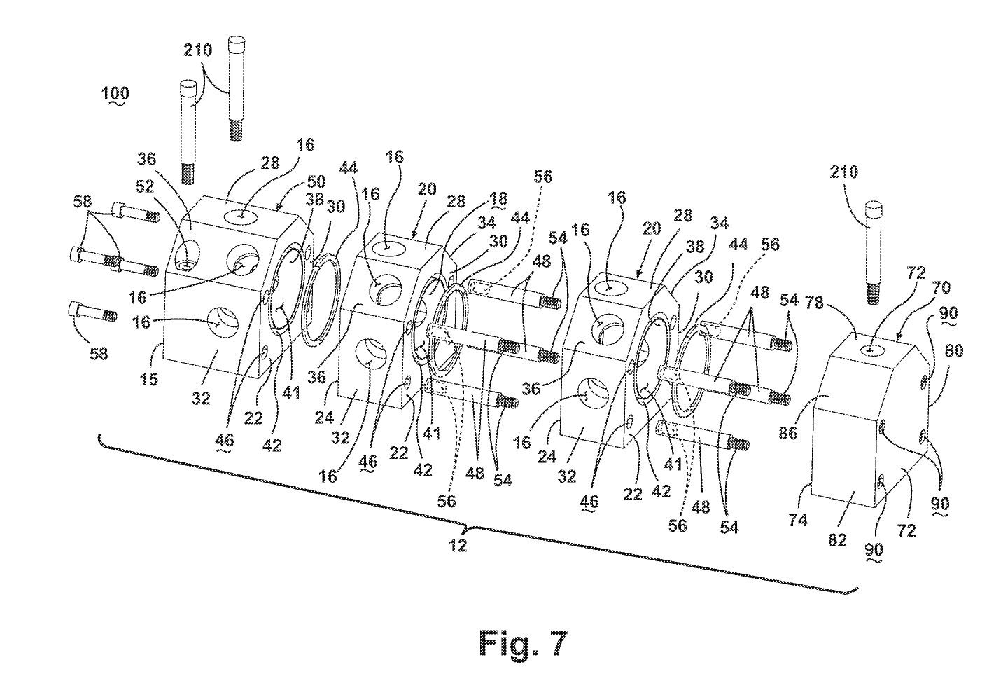

As illustrated in FIG. 7, in a third exemplary embodiment of the invention, a manifold 100 comprises a first end module 50, a stop module 70, and a pair of body modules 20, although any number and appropriate type of module can be utilized. Relative to the orientation illustrated in FIG. 7, the first end module 50 can be positioned with the first end face opening 14 on the left end of the manifold 100. The two body modules 20 can be positioned adjacent the first end module 50, and can be oriented with their first interior chamber openings 38 to the left. The stop module 70 can be positioned adjacent the body modules 20, and closes the interior chamber 18.

O-rings 44 can be seated in annular grooves 42 in each of the first end module 50 and the two body modules 20. The modules 50, 20, 20, 70 can be coupled together by tie-rods 48, cap screws 58, and nuts, as described hereinbefore. In this manner, each module 50, 20, 20 can be sealed against the adjacent module 20, 20, 70.

In operation, the first end face opening 14 can be fluidly coupled with a primary fluid line (not shown) associated with a cooling circuit supplying coolant to a heat-generating industrial production process. Secondary fluid lines (not shown) can be fluidly coupled to each of the fixture ports 16 and a fabrication apparatus for distribution through the fixture ports 16 to the fabrication apparatus fluid passages (not shown).The stop module 70 closes off the interior chamber 18, thus all the fluid that enters from the first end face opening 14 passes through the plurality of fixture ports 16.

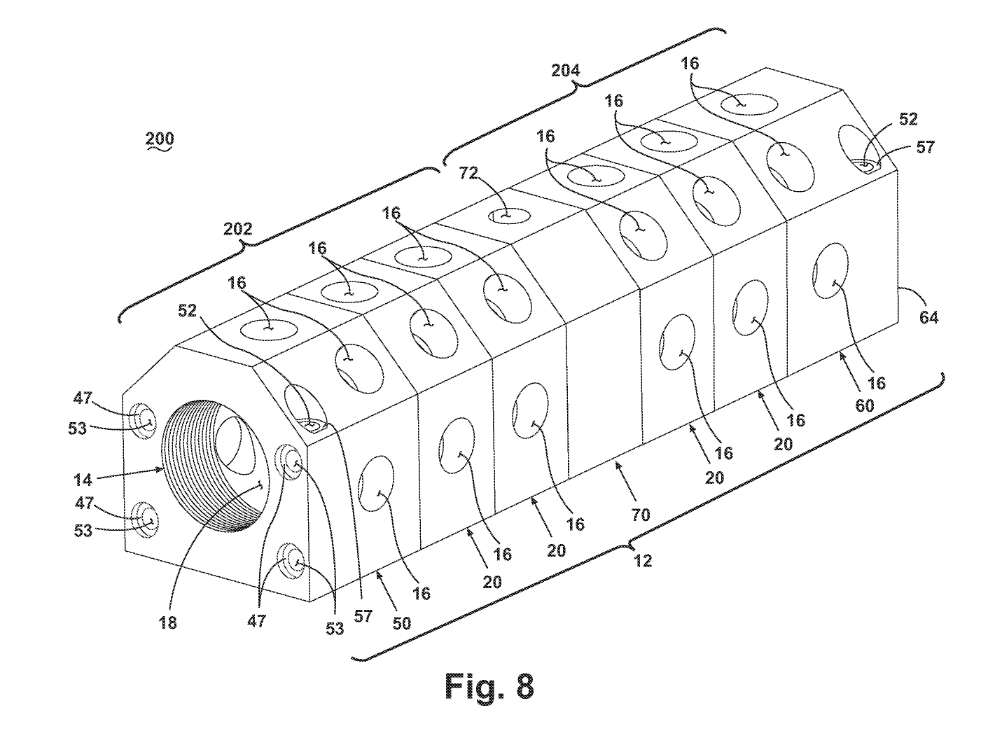

The manifold can also control both the distribution and return of cooling fluid. As illustrated in FIG. 8, a fourth exemplary embodiment of a modular manifold 200 comprises two halves, the first defined as a cool fluid distribution half 202 and the second defined as a warm fluid return half 204. The distribution and return halves 202, 204 are illustrated positioned back-to-back. However, alternate configurations can be employed, for example, a distribution half 202 sandwiched between return halves 204.

The distribution half 202 can comprise the first end module 50 and a plurality of body modules 20. The return half 204 can comprise a plurality of body modules 20 and the second end module 60. The return half 204 and distribution half 202 can be separated by a single stop module 70. All cap screw and tie-rod connections can be as previously described.

O-rings 44 can be seated in the annular groove 42 of each of the first end module 50, the stop module 70, and the body modules 20 to seal each module against an adjacent module.

In operation, the first end face opening 14, which can be located in the distribution half 202, can be fluidly coupled with a primary fluid supply line (not shown) that provides cooled fluid to the manifold 200. Secondary fluid lines (not shown) can be fluidly coupled with each of the fixture ports 16 and a fabrication apparatus (not shown), thereby enabling the flow of cooling fluid from the first end face opening 14, through the fixture ports 16 and fluid passages (not shown) in the fabrication apparatus. Fluid that has been warmed during flow through the fluid passages of the fabrication apparatus can enter the return half 204 through secondary fluid lines (not shown) fluidly coupled with each of the fixture ports 16 in the return half 204. The second end face opening 62 in the return half 204 can be fluidly coupled with a primary fluid return line (not shown) to carry the heated fluid away from the manifold 200 for cooling if the system is a closed circuit, or disposal if it is not. The stop module 70 can separate the interior chamber 18 into 2 half-chambers, and thus segregate the fluid of the return half 204 from that of the distribution half 202.

The manifold 10, 100, 200 can be made of a material having a suitable strength and durability, such as aluminum, carbon steel, stainless steel, or high-strength polymers. Particularly with injection molded or similarly fabricated polymeric manifold components, end face openings and fixture ports can have smooth interior surfaces adapted to receive threaded inserts for coupling of fluid lines, fasteners, and the like, with the modules. The manifold modules can also be colored, such as by anodizing, to provide corrosion resistance from the cooling fluid, and to quickly identify supply and return portions. Blue can denote cooled fluid, and red can denote warm fluid. Additionally, modules can be colored or marked for ready identification and efficiency in assembly.

The manifold 10, 100, 200 can be placed at a selected location relative to the fabrication apparatus, and mounted to a mounting surface by passing a fastener 210 (FIGS. 6 and 7) through the smooth-sided mounting bore 52 and into a threaded receptacle in the mounting surface.

The modular manifold described herein can provide several significant benefits. The manifold's modularity can readily enable customized configurations and facilitate manifold assembly, thereby reducing assembly and down times. Modularity can also enable quick module substitutions or additions. Differing configurations of the modules can satisfy a wide range of cooling performance requirements. Furthermore, the modules, tie-rods, fasteners, and other manifold components, can be disassembled once a particular fabrication apparatus is no longer in use, reconfigured, and reused in a different cooling application. This modularity can reduce costs for fabricators and, consequently, consumers, and is “green,” i.e. environmentally friendly.

While the invention has been specifically described in connection with certain specific embodiments thereof, it is to be understood that this is by way of illustration and not of limitation. Reasonable variation and modification are possible within the scope of the forgoing description and drawings without departing from the spirit of the invention, which is described in the appended claims.

What is claimed is:

1. A modular fluid manifold for accommodating a flow of fluid from a fluid source to at least one distribution point, said modular fluid manifold comprising:
at least two modules, each module including:
a body including a pair of opposed end faces, a bottom face and an opposed top face, and a pair of opposed side faces;
an opening in each of said opposed end faces fluidly coupled to define a portion of an interior chamber extending through said body;
at least one fixture port in at least one of said top face and said side faces fluidly coupled with said portion of said interior chamber;
at least one through-hole extending through said body between said opposed end faces; and
at least one fastener for insertion through said at least one through-hole;
wherein an end face of said first one of said modules and an end face of said second one of said modules can be placed in mutual contact for concentric disposition of said openings to define said interior chamber, and for concentric disposition of said through-holes;
wherein said at least one fastener can be inserted through said concentrically-disposed through-holes to fixedly join said at least two modules into said modular fluid manifold; and
wherein said at least one fixture port can be fluidly coupled with said at least one distribution point, and said opening in each of said non-contacting end faces can be fluidly coupled with said fluid source.

2. A modular fluid manifold according to claim 1 wherein said opening in one of said at least two modules is threaded.

3. A modular fluid manifold according to claim 1 wherein said at least one fixture port is threaded.

4. A modular fluid manifold according to claim 1, and further comprising a groove extending around said opening in one of said end faces, and an O-ring seated in said groove.

5. A modular fluid manifold according to claim 4 wherein said O-ring seated in said groove can contact an ungrooved one of said end faces to form a fluid-tight seal when said at least two modules are fixedly joined.

6. A modular fluid manifold according to claim 1, and further comprising a stop module including a body including a pair of opposed end faces, a bottom face and an opposed top face, and a pair of opposed side faces, and at least one through-hole extending through said body between said opposed end faces.

7. A modular fluid manifold according to claim 6 wherein one of said end faces of said stop module and an end face of one of said at least two modules can be placed in mutual contact for concentric disposition of said through-holes and fixed joining of said stop module and one of said at least two modules.

8. A modular fluid manifold according to claim 6 wherein said at least one fastener can be inserted through said concentrically-disposed through-holes to fixedly join stop module said at least two modules into said modular fluid manifold.
